(19) United States
(12) Patent Application Publication
(10) Pub. No.: US 2016/0019303 A1
(43) Pub. Date: Jan. 21, 2016

(54) SYSTEM AND METHOD FOR IDENTIFYING PATTERNS IN DATA FOR MAKING RECOMMENDATIONS OR DECISIONS

(71) Applicant: Attensity Group, Inc., Redwood City, CA (US)

(72) Inventor: Alan Littleford, Los Altos, CA (US)

(73) Assignee: Attensity Group, Inc., Redwood City, CA (US)

(21) Appl. No.: 14/797,812

(22) Filed: Jul. 13, 2015

Related U.S. Application Data
(60) Provisional application No. 62/026,977, filed on Jul. 21, 2014.

(51) Int. Cl. G06F 17/30

(52) U.S. Cl. CPC G06F 17/30867

(57) ABSTRACT

A system comprises: a filter actor execution system configured to execute filter actors to identify content items relevant to a topic of interest, each filter actor configured to examine the content items for satisfaction of filter criteria and to identify a subset of content items that satisfy the filter criteria; a deep review actor execution system configured to execute deep review actors to conduct deep review processing of the subset of content items, each deep review actor configured to perform semantic analysis on the subset of content items to generate deep review actor data; a correlation actor execution system configured to execute correlation actors to identify links within the subset of content items; a complex event actor execution system configured to execute complex event actors to identify patterns within the subset of content items; and an actor management system configured to instantiate the hierarchy of actors.

### CROSS-REFERENCE TO RELATED APPLICATIONS

The present application claims priority to U.S. Provisional Patent Application Ser. No. 62/026,977, filed Jul. 21, 2014 and entitled “System and Method for Identifying Patterns in Data for Making Recommendations or Decisions,” which is incorporated herein by reference.

### TECHNICAL FIELD

The technical field relates to data processing systems and methods. More specifically, the technical field relates to systems and methods for identifying and evaluating events and chains of events.

### BACKGROUND

Various data sources have allowed people to document and share information with one another over computer networks. For example, social media sources such as Facebook and LinkedIn have allowed people to share messages, photos, videos, files, etc. about personal or professional items of significance to them or others. As another example, weblogging sources such as BlogSpot and Twitter have allowed people to incorporate a variety of perspectives about events, people, places, products, etc. into data feeds that are shared with other users. As yet another example, business media sources, such as finance websites and internal corporate intranet sites, have allowed people to document and post press releases, financial reports, and/or stock price information.

While most data sources highlight the events and provide valuable information on the facts they are reporting, the information presented is limited to the content of the postings. It would be helpful if systems and methods existed that could learn deeper and more insightful information about topics of interest than just the content reported in the postings.

### SUMMARY

In some embodiments, an actor network system is configured to extract relevant information, such as opinions, complaints, reviews, news events, stock prices, etc., from content items in public and/or private data sources and to identify correlations, patterns, predictions, recommendations and/or decisions. The actor network system may filter content items based on the presence of language relevant to a topic of interest. The actor network system may perform deep review (semantic analysis) of the filtered content items to identify sentiment, intent, context, etc. The actor network system may correlate the filtered content items to identify links, e.g., commonalities, associations, relationships, etc. For example, the actor network system may identify links between content items and stock price, links between content items and new management, links between content items and key influencers, etc. The actor network system may identify patterns, explain events, determine patterns, predict events, and/or recommend actions.

As an example, the actor network system may be used to identify product defects in a toaster model sold by a particular distributer by identifying and evaluating a series of content items (e.g., tweets) about a failing toaster. The actor network system may identify the product defect early, before many people are injured. The actor network system 100 may be used to recognize correlations between the product defects and changes in stock price. The actor network system may be used to predict the departure of a company's CTO. As other examples, the actor network system may be used to provide insight into off-label drug use, crimes being committed, key influencers of the sales of products, geographies that will offer better results from marketing, etc.

Embodiments of the present invention provide a system comprising a filter actor execution system configured to execute one or more filter actors to identify content items relevant to a topic of interest, each filter actor configured to examine the content items for satisfaction of filter criteria and to identify a subset of content items that satisfy the filter criteria; a deep review actor execution system configured to execute one or more deep review actors to conduct deep review processing of the subset of content items, each deep review actor configured to perform semantic analysis on the subset of content items to generate deep review actor data; a correlation actor execution system configured to execute one or more correlation actors to identify one or more links within the subset of content items; a complex event actor execution system configured to execute one or more complex event actors to identify one or more patterns within the subset of content items; and an actor management system configured to instantiate the one or more filter actors, the one or more deep review actors, the one or more correlation actors, and the one or more complex event actors.

The actor management system may include at least one of a filter actor template, a deep review actor template, a correlation actor template and a complex event actor template. At least one filter actor, deep review actor, correlation actor or complex event actor may have a finite lifespan. At least one filter actor, deep review actor, correlation actor or complex event actor may terminate after a predetermined time, after the occurrence of a predetermined event, or after a manual instruction. At least one of the one or more filter actors, deep review actors, correlation actors or complex event actors may be a parent actor, and the parent actor may assist in generating a child filter actor, a child deep review actor, a child correlation actor or a child complex event actor. The child filter actor, the child deep review actor, the child correlation actor or the child complex event actor may terminate in response when the parent actor terminates. The one or more complex event actors may be further configured to make predictions, to make recommendations, and/or to make decisions based on the one or more patterns identified. The one or more filter actors may include at least one private filter actor or at least one public filter actor.

Embodiments of the invention may provide a method comprising instantiating one or more filter actors, one or more deep review actors, one or more correlation actors, and one or more complex event actors; executing the one or more filter actors to identify content items relevant to a topic of interest, each filter actor configured to examine the content items for satisfaction of filter criteria and to identify a subset of content items that satisfy the filter criteria; executing the one or more deep review actors to conduct deep review processing of the subset of content items, each deep review actor configured to perform semantic analysis on the subset of content items to generate deep review actor data; and executing the one or more correlation actors to identify one or more links within the subset of content items; executing the one or more complex event actors to identify one or more patterns within the subset of content items.

The step of instantiating may include using at least one of a filter actor template, a deep review actor template, a correlation actor template and a complex event actor template. The method may further comprise automatically terminating at least one filter actor, deep review actor, correlation actor or complex event actor. The step of automatically terminating the at least one filter actor, deep review actor, correlation actor or complex event actor may occur after a predetermined time, after the occurrence of a predetermined event, or after a manual instruction. At least one of the one or more filter actors, deep review actors, correlation actors or complex event actors may be a parent actor, and the method may further comprise receiving information from the parent actor to assist in generating a child filter actor, a child deep review actor, a child correlation actor or a child complex event actor. The method may further comprise automatically terminating the child filter actor, the child deep review actor, the child correlation actor or the child complex event actor in response to termination of the parent actor. The method may further comprise executing the one or more complex event actors to make predictions, make recommendations and/or make decisions based on the one or more patterns identified. The one or more filter actors may include at least one private filter actor or at least one public filter actor.

### BRIEF DESCRIPTION OF THE DRAWINGS

FIG. 1 depicts an example actor network system, according to some embodiments.

FIG. 2 depicts an example data processing system, according to some embodiments.

FIG. 3 depicts an example actor management system, according to some embodiments.

FIG. 4 depicts a flowchart of an example method for using actors to identify patterns, make predictions, make recommendations and/or make decisions, according to some embodiments.

FIG. 5 depicts a flowchart of an example method for generating one or more actors, according to some embodiments.

FIG. 6 depicts an example report showing analysis of content items from a public data source, according to some embodiments.

FIG. 7 depicts an example report showing analysis of a particular hashtag from a public data source, according to some embodiments

FIG. 8 depicts an example report showing analysis of a particular topic of interest, according to some embodiments.

FIG. 9 depicts an example report showing patterns associated with content items related to one or more topics of interest, according to some embodiments.

FIG. 10 depicts an example block diagram of three applications that predict different patterns related to an event posted in patent reports and emails, according to some embodiments.

FIG. 11 depicts an example block diagram of three applications that predict different patterns related to an event posted in patent reports and emails, according to some embodiments.

FIG. 12 depicts an example block diagram of a system architecture for analyzing data using actors, according to some embodiments.

FIG. 13 depicts an example of a digital device, according to some embodiments.

### DETAILED DESCRIPTION

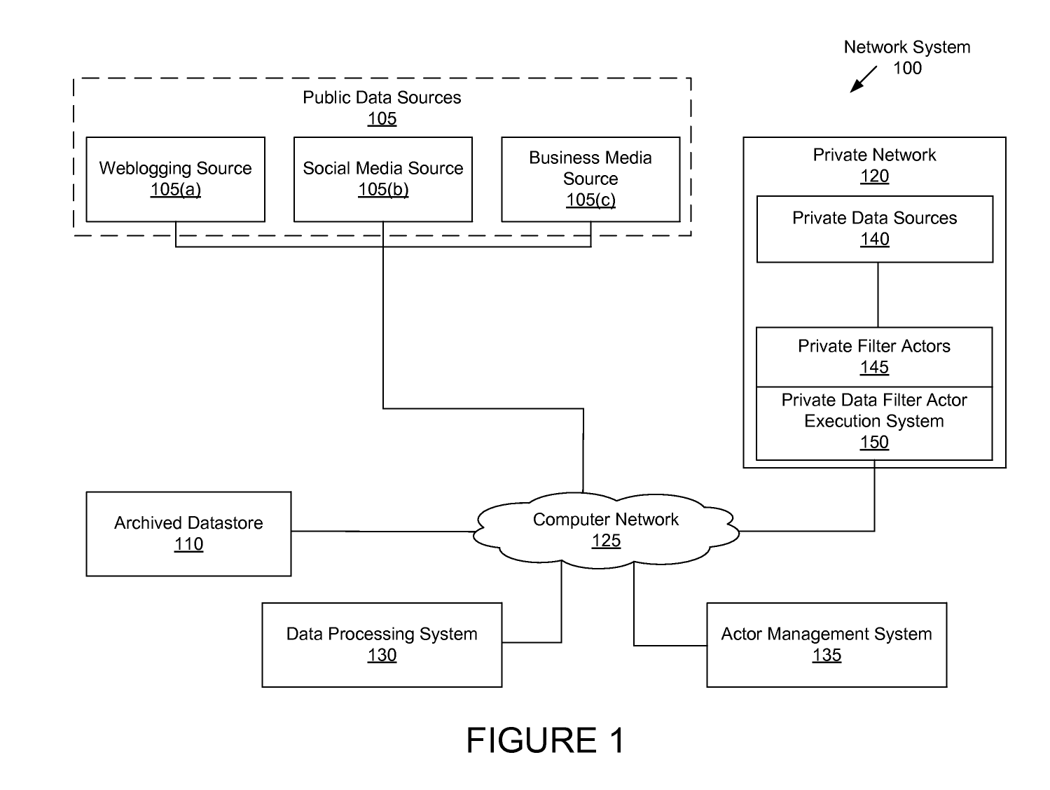

FIG. 1 depicts an example of an actor network system 100, according to some embodiments. The actor network system 100 is configured to extract relevant information, such as opinions, complaints, reviews, news events, stock prices, etc., from content items in public and/or private data sources and to identify correlations, patterns, predictions, recommendations and/or decisions. In some embodiments, the actor network system 100 may filter content items based on the presence of language relevant to a topic of interest. The actor network system 100 may perform deep review (semantic analysis) of the filtered content items to identify sentiment, intent, context, etc. The actor network system 100 may correlate the filtered content items to identify links, e.g., commonalities, associations, relationships, etc. For example, the actor network system 100 may identify links between content items and stock price, links between content items and new management, links between content items and key influencers, etc. The actor network system 100 may identify patterns, explain events, determine patterns, predict events, and/or recommend actions.

As an example, the actor network system 100 may be used to identify product defects in a toaster model sold by a particular distributer by identifying and evaluating a series of content items (e.g., tweets) about a failing toaster. The actor network system 100 may identify the product defect early, before many people are injured. The actor network system 100 may be used to recognize correlations between the product defects and changes in stock price. The actor network system 100 may be used to predict the departure of a company's CTO. As other examples, the actor network system 100 may be used to provide insight into off-label drug use, crimes being committed, key influencers of the sales of products, geographies that will offer better results from marketing, etc.

As shown in FIG. 1, the actor network system 100 includes public data sources 105, an archived data store 110, a private network 120, an actor management system 135, and a data processing system 130, each coupled to a computer network 125. The couplings of FIG. 1 are by way of illustration only, and the components of the actor network system 100 may be coupled in other ways without departing from the scope and substance of the concepts described herein.

The public data sources 105 may comprise a weblogging source 105(a), a social media source 105(b), and a business media source 105(c). “Public data,” as used herein, may refer to content items that are available or made available to the data processing system 130 and/or the actor management system 135. The weblogging source 105(a) may include weblog data, such as tweets, posts, etc., from users. An example of the weblogging source 105(a) is Twitter®. The social media source 105(b) may include social media data from users. Social media data may include social media messages, social media posts, likes, pokes, etc. Examples of the social media source 105(b) include Facebook® and LinkedIn®. The business media source 105(c) may include business media data from users. Examples of business media data include news content, publicly available information about businesses, and other public content. Although FIG. 1 shows the weblogging source 105(a), the social media source 105(b), and the business media source 105(c) as separate sources of public data, they need not be separate sources. In other words, one or more of the weblogging source 105(a), the social media source 105(b), and the business media source 105(c) may provide multiple types of public data.

The archived data store 110 may archive public data of the public data sources 105 for future use. The archived data store 110 may collect the public data at various times, substantially continuously, after predetermined events, etc. In some embodiments, the archived data store 110 may collect the public data as the public data is published. In embodiments, the archived data store 110 may collect the public data at various intervals of time, such as hourly, daily, weekly, monthly, etc.

The private network 120 may include hardware and/or software resources that are publicly inaccessible. The private network 120 may be associated with an enterprise, such as a company, a school, or a hospital. The private network 120 may comprise a secure computer network. The private network 120 may include private data sources 140, private filter actors 145 and a private data filter actor execution system 150. The private data sources 140 include private data. “Private data,” as used herein, may refer to data that is inaccessible outside the private network 120. The private data sources 140 may include a private weblogging source, a private social media source, a private business media source, user files, patient data, school records, etc. The private data filter actor execution system 150 may be coupled to the private data sources 140 and to the computer network 125. The couplings of FIG. 1 are by way of illustration only, and the components of the private network 120 may be coupled in other ways without departing from the scope and substance of the inventive concepts described herein.

The private filter actors 145 include a set of filter actors configured to gather content items from the private data sources 140. The private filter actors 145 may use filter criteria to determine whether content items are sufficiently associated with a topic of interest to be considered for further evaluation. In some embodiments, the private filter actors 145 are configured to search for keywords provided by the user, associated with the topic of interest, and/or identified by one of the other actors in the system (e.g., by a deep review actor, a correlation actor, a complex event actor and/or another filter actor). The private filter actors 145 may reside in memory until the private filter actors 145 are deployed to the private data filter actor execution system 150. In some embodiments, the private filter actors 145 and the private data filter actor execution system 150 reside on the servers that manage the private data sources 140.

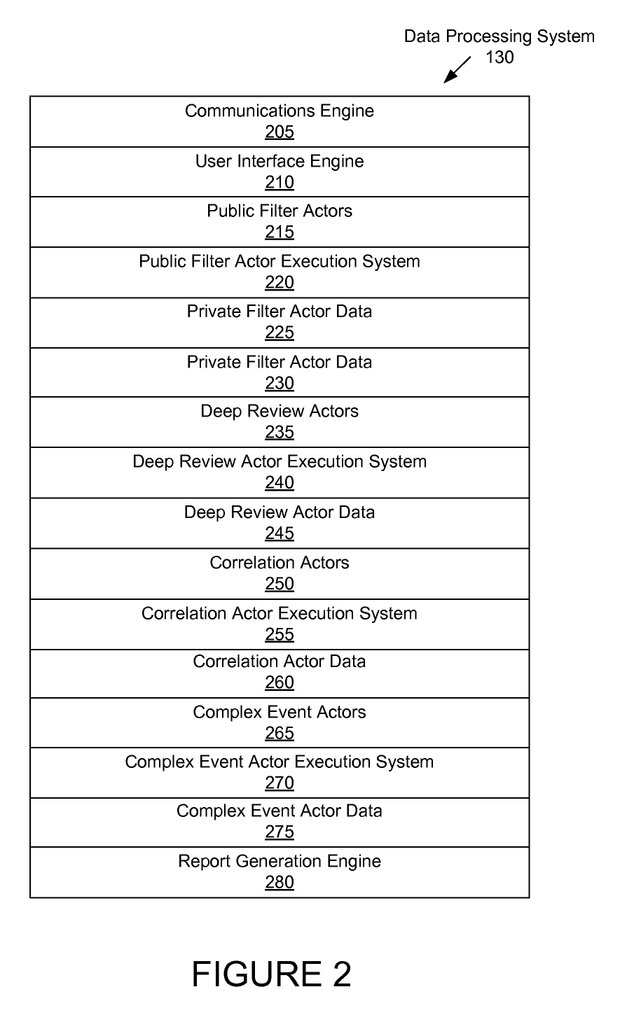

The private data filter actor execution system 150 may execute the private filter actors 145. The private data filter actor execution system 150 may be implemented using one or more virtual machine frameworks, such as the Akka framework for JVM. Executing the private filter actors 145 may result in private filter actor data, which is sent to the data processing system 130 for evaluation. Because the private data sources 140 may include sensitive information, it is possible that the private network 120 may not want all data to be accessible to the data processing system 130 and/or to the actor management system 135. Additional details about actors (e.g., filter actors) and filter actor execution systems 150 (e.g., private data filter actor executions system 150) are described below with reference to FIG. 2.

The data processing system 130 may examine the public data gathered from the public data sources 105 and/or the private data gathered from the private data sources 140. The data processing system 130 may execute filter actors to associate content items with a topic of interest, deep review actors to perform deep review on the filtered content items, correlation actors to identify correlations in the filtered content items, and complex event actors to identify patterns, make predictions, make recommendations and/or make decisions. FIG. 2 shows the data processing system 130 in greater detail.

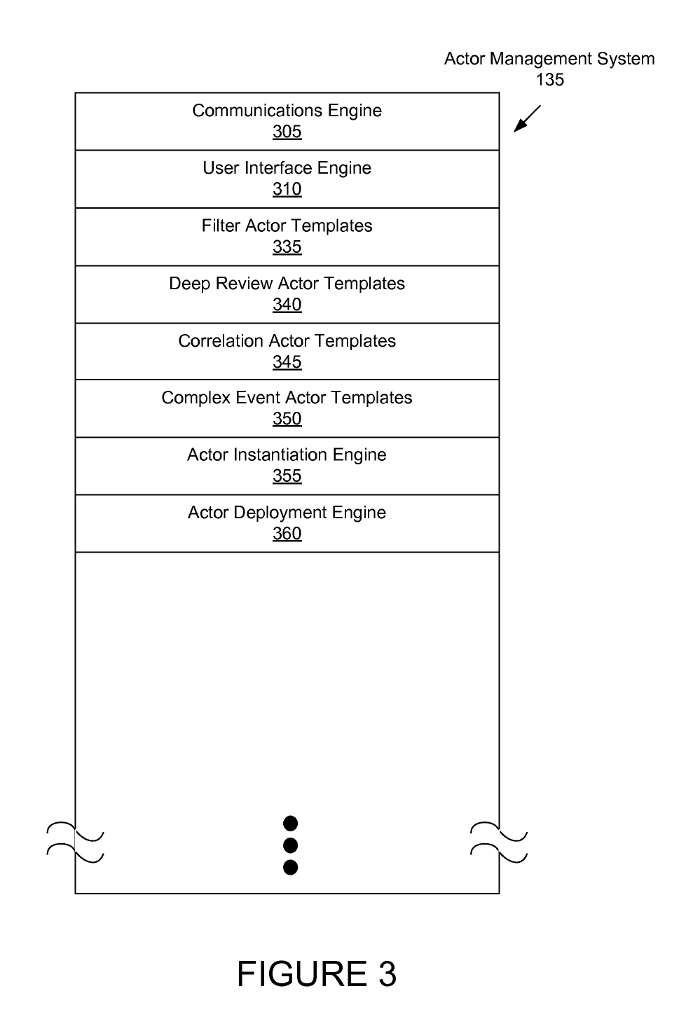

The actor management system 135 may manage instantiation and/or deployment of actors. The actor management system 135 may include filter actor templates, deep review actor templates, correlation actor templates, and complex event actors. FIG. 3 shows the actor management system 135 in greater detail.

The computer network 125 may include any medium that facilitates coupling of digital devices to one another. The computer network 125 may include technologies such as Ethernet, 802.11x, worldwide interoperability for microwave access WiMAX, 2G, 3G, 4G, CDMA, GSM, LTE, digital subscriber line (DSL), and/or the like. The computer network 125 may further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and/or the like. The data exchanged over the computer network 125 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec). Though element 125 is labeled a “computer network” in FIG. 1, it is noted that in various embodiments, the element 125 may refer to any medium that facilitates digital devices to other digital devices, or components of digital devices to other components of digital devices. In various embodiments, the element 125 may refer to a bus or a device used to facilitate minimalist coupling of components of a digital device.

FIG. 2 depicts an example data processing system 130, according to some embodiments. The data processing system 130 includes a communications engine 205, a user interface engine 210, public filter actors 215, a public filter actor execution system 220, public filter actor data 225, private filter actor data 230, deep review actors 235, a deep review actor execution system 240, deep review actor data 245, correlation actors 250, a correlation actor execution system 255, correlation actor data 260, complex event actors 265, a complex event actor execution system 270, complex event actor data 275, and a report generation engine 280. One or more of the components of the data processing system 130 may include hardware, software and/or firmware.

The communications engine 205 may facilitate communication over the computer network 125 (shown in FIG. 1) with other devices. The communications engine 205 may transform data from one or more of the modules of the data processing system 130 into a format compatible with the protocols of the computer network 125. The communications engine 205 may also transform data received over the computer network 125 into a format compatible with the components of the data processing system 130. The communications engine 205 may include network interface hardware and/or software that couples the data processing system 130 to the computer network 125.

The user interface engine 210 may interface with a user of the data processing system 130. In some embodiments, the user interface engine 210 supports a graphical user interface (GUI). The user interface engine 210 may allow users to select topics of interest and/or particular data sources to evaluate. Such topics of interest may form criteria for evaluating content items, e.g., the filter criteria for filter actors. In some embodiments, the topics of interest may include keywords for the filter actor to find in a content item, for the content item to be deemed relevant. The user interface engine 210 may also present filtered content items, semantic results, identified patterns, predictions, recommendations or decisions. The user interface engine 210 may display reports.

The public filter actors 215 include a set of filter actors configured to gather content items from the public data sources 105 or from the archive data store 145. The public filter actors 215 may be similar to the private filter actors 145. The public filter actors 215 may use filter criteria to determine whether content items are sufficiently associated with a topic of interest to be considered for further evaluation. In some embodiments, the public filter actors 215 are configured to search for keywords provided by the user, associated with the topic of interest, and/or identified by one of the other actors in the system (e.g., by a deep review actor, a correlation actor, a complex event actor and/or another filter actor). The public filter actors 215 may reside in memory of the data processing system 130 until the public filter actors are deployed to the public data filter actor execution system 115. In some embodiments, the public filter actors 215 and the public data filter actor execution system 115 resides on the servers that manage the public data sources 105 and/or on the servers that manage the archive data store 145.

An “actor,” as used herein, may refer to one or more processes that are configured to take specified actions on content items. Examples of actions taken by actors include: searching for keywords, performing logical functions, creating other actors, sending and/or receiving messages to other actors, and managing other actors. An actor may be executed on a single thread or a number of threads. In some embodiments, actors may be implemented using the Akka framework for JVM. The use of actors to take actions on content items may allow analysis of the content items without the need to cache and query the content items.

Once an actor has achieved its specified purpose, the actor may terminate. As a result, in various embodiments, an actor may have a finite lifespan. An actor may terminate upon the occurrence of a predetermined time, the occurrence of a predetermined event, and/or the receipt of a manual instruction to terminate the actor. In some embodiments, actors, known as “parent actors,” may provide instructions to create other actors, known as “child actors.” In various embodiments, child actors may automatically terminate when they have achieved their specified purpose or may terminate if their parent actor terminates, e.g., upon being notified or detecting that the parent actor is terminating or has terminated.

A “filter actor,” as used herein, may refer to an actor configured to use filter criteria (e.g., keywords) to determine a possible association with a topic of interest. The particular filter actors for specific content items may depend on various use cases. For example, filter actors for identifying and/or assessing potential product defects of a product may evaluate the data for the presence of one or more variations of the product name. Filter actors evaluating data for corporate intelligence related to an executive's career transitions may evaluate the data for the presence of the executive's name and/or the name of companies the executive worked for. Filter actors looking for off-label drug use may evaluate data for the presence of the name of the drug and/or the conditions for which it is typically used. Filter actors looking for crimes that have been committed may evaluate the data for the presence of the name of the crimes or specific penal code sections being investigated. The filter actor (e.g., public filter actor 215 or private filter actor 145) will generate filter actor data (e.g., public filter actor data 225 or private filter actor data 230). One skilled in the art will recognize that, in various embodiments, public filter actors 215 and private filter actors 145 can be effectively the same. So, herein, when referring to a public filter actor 215, the same may apply to a private filter actor 145. Generically, they may be referred to as a “filter actor,” a “filter actor 215,” a “filter actor 145” or a “filter actor 215 or 145.”

The public data filter actor execution system 115 executes the public filter actors 215. In some embodiments, the public data filter actor execution system 115 may be implemented using one or more virtual machines. For example, the public data filter actor execution system 115 may be implemented using a Java Virtual Machine (JVM) framework such as the Akka framework for JVM.

The public filter actor data 225 includes data generated by the public filter actors 215. The public filter actor data 225 may be stored on a persistent storage on the data processing system 130. The public filter actor data 225 may include the content items, portions of content items, summaries of content items, interpretation of the content items, metadata, etc. generated by the public filter actors 215. In some embodiments, the public filter actor data 225 is the filtered data deemed related to the topic of interest.

The private filter actor data 230 includes data generated by the private filter actors 145. The private filter actor data 230 may be stored on a persistent storage on the data processing system 130. The private filter actor data 230 may include the content items, portions of content items, summaries of content items, interpretation of the content items, metadata, etc. generated by the private filter actors 145. In some embodiments, the private filter actor data 230 is the filtered private data deemed related to the topic of interest.

For example, the public filter actors 215 and the private filter actors 145 may be configured to search for information regarding a toaster of brand, Model X. The public filter actors 215 and private filter actors 145 may be configured to capture every tweet, blog posting, article, etc. associated with toasters of brand, Model X. The filter actors may be configured to search the tweets, blog postings, articles, etc. for any that contain the keywords “toaster” and “Model X.” The resulting data is the public filter actor data 225 or private filter actor data 230.

The deep review actors 235 may include a set of actors configured to be executed by the deep review actor execution system 240 to perform deep review processing of the filtered content items. “Deep review” or “deep review processing,” as used herein, may refer to semantic processing and/or natural language processing of content items to generate deep review actor data 245, which may include natural language elements, such as opinions, sentiments, context and intents. The deep review actor execution system 240 may be implemented using one or more virtual machine frameworks, such as the Akka framework for JVM. The deep review actor data 245 may be stored on a persistent storage on the data processing system 130.

Following on the example above, the deep review actors 235 may be configured to search for opinions, intent, context and sentiment in the public filter actor data 225 and the private filter actor data 230. The deep review actors 235 may determine that a significant percentage people talking about the toasters of brand, Model X, are speaking negatively about it, have no intentions to purchase it, and may be recommending that it be deemed a fire hazard.

The correlation actors 250 may include a set of actors configured to be executed by the correlation actor execution system 255 to identify relationships between/among the filtered content items. The correlation actors 250 may try to identify the relationship the filtered content items have with other words, other content items, specific data sources, key people, key geographies, business choices, business value, etc. The correlation actors 250 may try to identify whether a particular person seems to be influencing the opinions of others, the sale of a product, etc. The correlation actor execution system 255 may be implemented using one or more virtual machine frameworks, such as the Akka framework for JVM. The correlation actor data 260 may be stored on a persistent storage on the data processing system 130.

Following on the example above, the correlation actors 250 may be configured to monitor for relationships in the filtered content items to determine if complaints about toasters of brand, Model X, are centralized about a specific geography, centralized about a particular store, centralized about a particular date/time range, centralized about particular news events, etc. The correlation actors 250 may be configured to evaluate whether content items and/or the real-life events are influencing stock price, sales, public opinion, etc.

The complex event actors 265 may include a set of actors configured to be executed by the complex event actor execution system 255 to identify patterns, make predictions and/or recommend actions. The complex event actor execution system 270 may be implemented using one or more virtual machine frameworks, such as the Akka framework for JVM. The complex event actor data 275 may be stored on a persistent storage on the data processing system 130.

Following on the example above, the complex event actors 265 may identify that toasters of brand, Model X, have appeared in several postings that have included the words “failure” or “broken.” The complex event actors 265 may associate the postings with the toaster of brand, Model X, being defective. The complex event actors 265 may anticipate that the toaster company's stock prices might go down, that the Chief Technology Officer (CTO) of the toaster company may leave, etc. The complex event actors 265 may anticipate that, if the CTO is hired by a second company, that the second company is likely to release a toaster product.

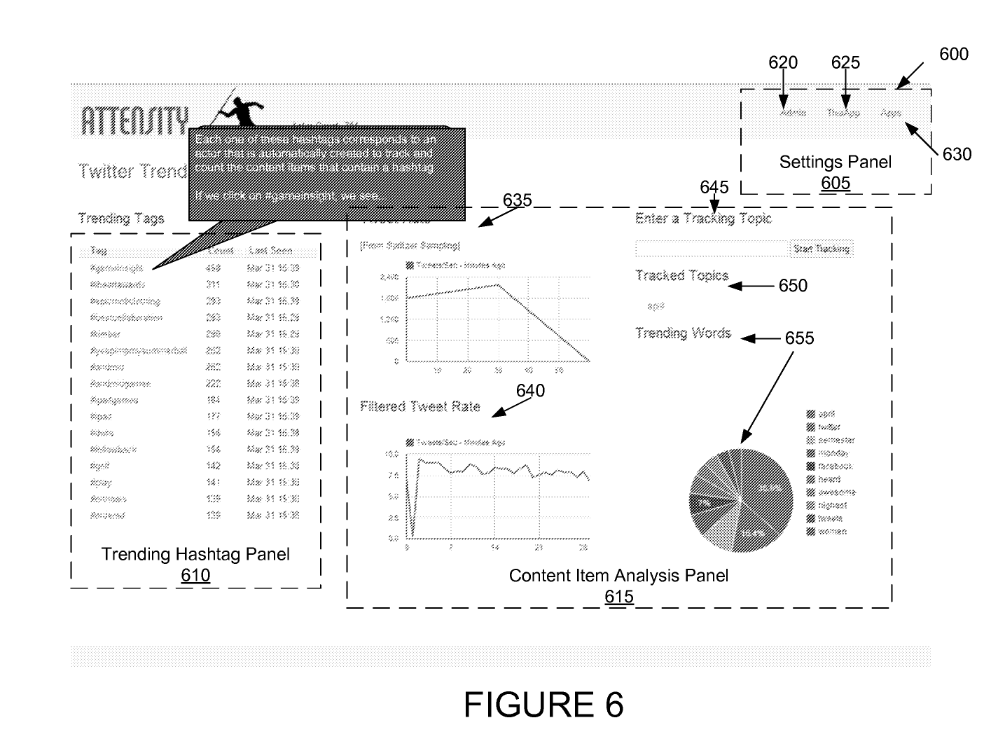

The report generation engine 280 may generate reports to identify filtered content items, to report opinions, sentiment, context and/or intent, to report correlations between events, to identify patterns, to make predictions, to make recommendations and/or to make decisions. The report generation engine 280 may provide a report to the user interface engine 210. FIGS. 6-9 show examples of reports that may be generated by the report generation engine 280.

It will be further appreciated that each of the public filter actors 215, private filter actors 145, deep review actors 235, correlation actors 250 and the complex event actors 265 may be capable of recommending the creation of other actors. For example, when performing semantic analysis on filtered content items regarding toasters of brand, Model X, a particular correlation actor 250 may determine that a significant number of the content items refer to fires and Store X, suggesting that all toasters of brand, Model X, purchased from Store X may be defective, risking fire. The particular correlation actor 250 may initiate the creation of another filter actor 215 and/or 145 to search for content items involving fires and Store X. Similarly, the correlation actor 250 may initiate the creation of another filter actor 215 or 145 to review other data sources (public or private) to search for similar information.

One skilled in the art will recognize that an actor network system 100 need not include all of filter actors 145/215, deep review actors 235, correlation actors 250, and complex event actors 265. There could be fewer or more actors in the actor hierarchy.

FIG. 3 depicts an example actor management system 135, according to some embodiments. The actor management system 135 may include a communications engine 305, a user interface engine 310, filter actor templates 335, deep review actor templates 340, correlation actor templates 345, complex event actor templates 350, an actor instantiation engine 355, and an actor deployment engine 360. One or more of the components of the actor management system 135 may include hardware, software and/or firmware.

The communications engine 305 may facilitate communication over the computer network 125 (shown in FIG. 1) with other devices. The communications engine 305 may be similar to the communications engine 205, shown in FIG. 2.

The user interface engine 310 may interface with a user of the actor management system 135. The user interface engine 310 may be similar to the user interface engine 210, shown in FIG. 2.

The filter actor templates 335 include one or more actor templates for creating filter actors 145 or 215. In some embodiments, a filter actor template 335 refers to a data structure that can be configured and executed to monitor a source of information for satisfaction of filter criteria. In some embodiments, the filter actor templates 335 may provide common classes and/or functions. In various embodiments, the filter actor templates 335 may be configured to search for specific words, related words, association with a topic of interest, etc.

The deep review actor templates 340 include one or more actor templates for creating deep review actors 235. In some embodiments, a deep review actor template 340 refers to a data structure that can be configured and executed to perform semantic processing and/or natural language processing (NLP) on content items to identify sentiments, intents, context and/or opinions in a content item. The deep review actor templates 340 may provide common classes and/or functions.

The correlation actor templates 345 include one or more actor templates for creating correlation actors 250. In some embodiments, a correlation actor template 345 refers to a data structure that can be configured and executed to identify relationships between/among the filtered content items, e.g., to identify the relationship filtered content items have with other words, other content items, specific data sources, key people, key geographies, business choices, business value, etc., and/or whether a particular person seems to be influencing the opinions of others, the sale of a product, etc. In some embodiments, the correlation actor templates 345 may provide common classes and/or functions.

The complex event actor templates 350 include one or more actor templates for creating complex event actors 265. In some embodiments, a complex event actor template 350 refers to a data structure that can be configured and executed to identify patterns, make predictions and/or recommend actions. In some embodiments, the complex event actor templates 350 may provide common classes and/or functions.

The actor instantiation engine 355 may instantiate actors using the filter actor templates 335, deep review actor templates 340, correlation actor templates 345, and/or complex event actor templates 350. The actor instantiation engine 355 may automatically instantiate actors, cooperate with the user interface engine 310 to enable a user to instantiate actors of interest, and/or communicate with other actors to receive requests, suggestions and/or instructions to instantiate other actors.

For example, a user may have interest in learning about toasters of brand, Model X. The user may create a filter actor 215 or 145 to search for content items having those terms. The actor instantiation engine 355 may automatically and/or with the assistance of the user generate deep review actors 235 to gather sentiment, intent, context and/or opinion information from the filtered opinions. The actor instantiation engine 355 may automatically and/or with the assistance of the user generate correlation actors 250 to identify relationships between/among the filtered content items, e.g., to identify the relationship filtered content items have with other words, other content items, specific data sources, key people, key geographies, business choices, business value, etc., and/or whether a particular person seems to be influencing the opinions of others, the sale of a product, etc. The actor instantiation engine 310 may automatically and/or with the assistance of the user generate complex event actors 265 to identify patterns, make predictions and/or recommend actions. In some embodiments, the actor instantiation engine 355 in cooperation with the user interface 310 may enable the user to explain a more detailed problem, issue, concern, curiosity, etc., and the actor instantiation 355 may automatically create all actors, including filter actors 145 and/or 215.

It will be appreciated that the actor instantiation engine 355 may cooperate with the communications engine 305 to communicate and receive directions from actors, e.g., filter actors 215 or 145, deep review actors 235, correlation actors 250 and/or complex event actors 265.

The actor deployment engine 360 may deploy instantiated actors. In embodiments, the actor deployment engine 360 may provide instantiated actors to the data processing system 130, the private network 120, the archive data store 110 or other device in the actor network system 100.

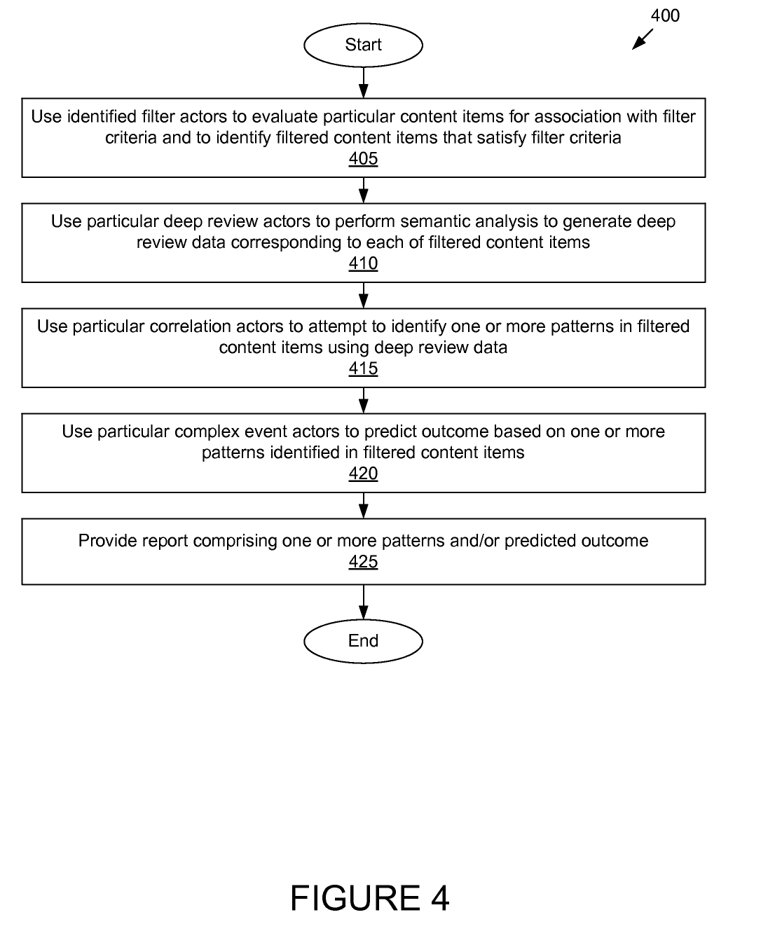

FIG. 4 is a flowchart of an example method 400 for using actors to evaluate content items, identify correlations, recognize patters, make predictions, make recommendations and/or make decisions. The method 400 is discussed in conjunction with the elements of the actor network system 100, shown in FIG. 1, and/or the data processing system 130, shown in FIG. 1 and FIG. 2. In some embodiments, the method 400 may include elements not explicitly depicted, and all elements are not necessary to perform the method 400.

At step 405, the filter actors 145 or 215 evaluate content items of a particular source 105 or 140 for association with filter criteria and to identify filtered content items that satisfy the filter criteria. The public filter actor execution system 220 may execute one or more public filter actors 215 to evaluate each of the content items of a public source for association with the filter criteria. The private filter actor execution system 150 may use one or more private filter actors 145 to evaluate each of the content items of a private source 140 for association with filter criteria and to identify filtered content items that satisfy the filter criteria. In some embodiments, the public filter actor execution system 220 and/or the private filter actor execution system 150 may gather content items that contain one or more keywords. In some embodiments, the public filter actor execution system 220 and/or the private filter actor execution system 150 may gather content items that have a particular hashtag. The public filter actor execution system 220 and/or the private filter actor execution system 150 may provide private filter actor data 230 to the data processing system 130.

At step 410, the deep review actor execution system 240 may execute particular deep review actors to perform semantic analysis and/or natural language processing (NLP) to generate deep review actor data 245 corresponding to each of the filtered content items. In various embodiments, the deep review actor execution system 240 may identify natural language processing elements, such as sentiment, opinion, context and intent, in each of the filtered content items. The deep review actor execution system 240 may provide the deep review actor data 245 to the data processing system 130.

At step 415, the correlation actor execution system 255 uses correlation actors 250 to attempt to identify one or more or more links, e.g., associations, relationships, etc., in the filtered content items using the deep review actor data 245. The correlation actor execution system 255 may provide the correlation actor data 260 to the data processing system 130.

At step 420, the complex event actor execution system 270 uses complex event actors 265 to identify patterns in the filtered content items, and to make predictions, recommendations and/or decisions based on the one or more patterns identified. In some embodiments, the complex event actors 265 may identify the extent deep review processing and/or correlations performed on a particular content item indicates an event has likely occurred or is likely to occur.

At step 425, the report generation engine 280 provides a report, e.g., to present the filtered content items, the correlations identified, the patterns identified, the predictions made, the recommendations made and/or the decisions made. Example reports are shown in FIGS. 6-9.

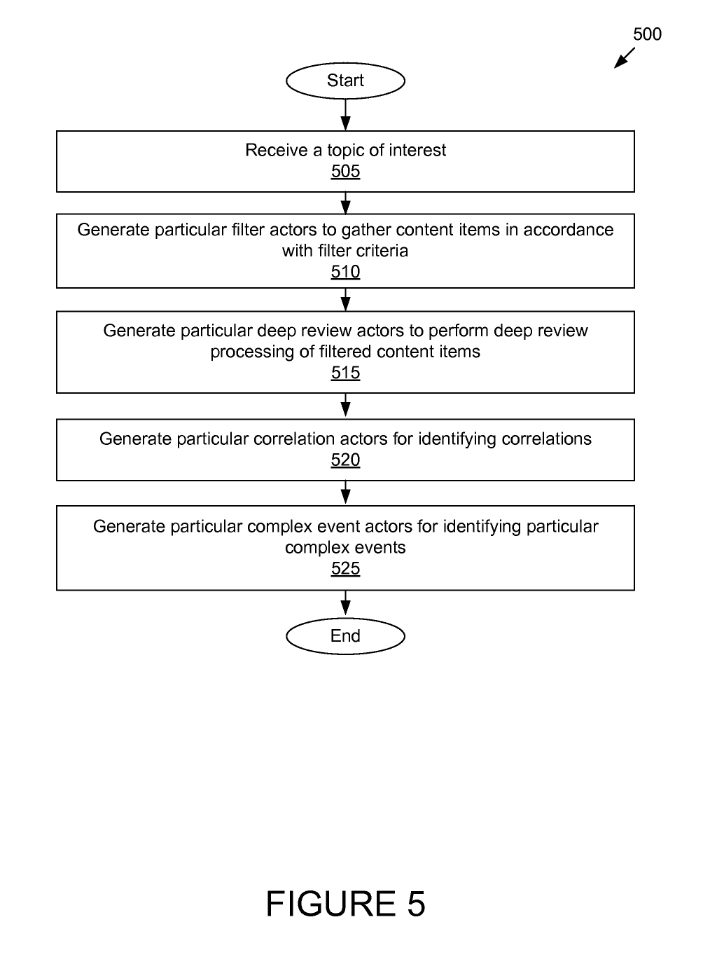

FIG. 5 depicts a flowchart of an example method 500 for generating one or more actors, according to some embodiments. The method 500 is discussed in conjunction with the elements of the data processing system 130, shown in FIG. 1 and FIG. 2, and the actor management system 135, shown in FIG. 1 and FIG. 3. The method may include elements not explicitly depicted in the method 500, and all elements are not necessary to perform the method 500.

At step 505, the user interface engine 310 receives information about a topic of interest from a user.

At step 510, the actor instantiation engine 355, possibly in cooperation with the user interface engine 310, generates filter criteria. The actor instantiation engine 355 uses the filter criteria and filter actor templates 355 to instantiate one or more filter actors 145 or 215 to gather content items in accordance with the filter criteria. The actor deployment engine 360 deploys the instantiated filter actors 145 or 215.

At step 515, the actor instantiation engine 355, possibly in cooperation with the user interface engine 310, uses the deep review actor templates 340 to instantiate deep review actors 235 to perform deep review processing on the filter actor data 230. The actor deployment engine 360 may deploy the instantiated deep review actors 235.

At step 540, the actor instantiation engine 355, possibly in cooperation with the user interface engine 310, uses the correlation actor templates 345 to instantiate particular correlation actors 250 to identify relationships between/among the filtered content items, e.g., to identify the relationship filtered content items have with other words, other content items, specific data sources, key people, key geographies, business choices, business value, etc., and/or whether a particular person seems to be influencing the opinions of others, the sale of a product, etc. The actor deployment engine 360 may deploy the correlation actors 250.

At step 545, the actor instantiation engine 355, possibly in cooperation with the user interface engine 310, uses the complex event actor templates 350 to instantiate particular complex event actors 265 to identify patterns, make predictions and/or recommend actions. The actor deployment engine 360 may deploy the complex event actors 265.

FIG. 6 depicts an example report 600 showing analysis of content items from a public data source, according to some embodiments. The public data source may correspond to the weblogging source 105(a), shown in FIG. 1. Further, the report 600 may have been generated by the report generation engine 280, shown in FIG. 2.

The report 600 includes settings panel 605, a trending hashtag panel 610, and a content item analysis panel 615. The settings panel 605 may allow a user to control various settings. The settings panel 605 may include an administration button 620, a particular application button 625, and a plurality of applications button 630. The administration button 620 may allow the user to control administrative settings, such as the user's account settings and password settings. The particular application button 625 may allow the user to control settings related to a particular application. The plurality of applications button 630 may allow the user to control settings related to a plurality of applications.

The trending hashtag panel 610 includes a list of hashtags that are being commonly associated with content items being posted to the weblogging source 105(a). The trending hashtag panel 610 also shows specific hashtags of content items. In some embodiments, the actor management system 135 may create a filter actor 215 for each hashtag in the trending hashtag panel 610. The public filter actor execution system 220 may execute the filter actors 215 created for the hashtags. Each created filter actor 215 may identify content items having filter criteria, such as a specific hashtag. Each filter actor 215 may compute the number of times specific hashtags have been identified in the weblogging source 105(a), and the time(s) content items with the specific hashtags were last posted.

The content item analysis panel 615 provides information about content items being posted to the weblogging source 105(a). The content item analysis panel 615 provides a posting rate 635, a filtered posting rate 640, a topic tracking field 645, a tracked topics list 650, and a trending words graph 655. The posting rate 635 provides how many content items are being posted to the weblogging source 105(a) as a function of time. The filtered posting rate 640 provides a filtered view of how many content items are being posted to the weblogging source 105(a) as a function of time. The topic tracking field 645 allows a user to enter particular topics of content items being posted to the weblogging source 105(a). The tracked topics list 650 displays the list of topics that have been tracked. The trending words graph 655 provides a list of popular words in content items being posted to the weblogging source 105(a). In this example, the words “april,” “twitter,” “semester,” “monday,” “facebook,” heard,” awesome,” “highest,” “tweets,” and “women” are popular among content items posted to the weblogging source 105(a). The items in the content item analysis panel 615 may be obtained from filter actors 215 and/or other actors, as described herein.

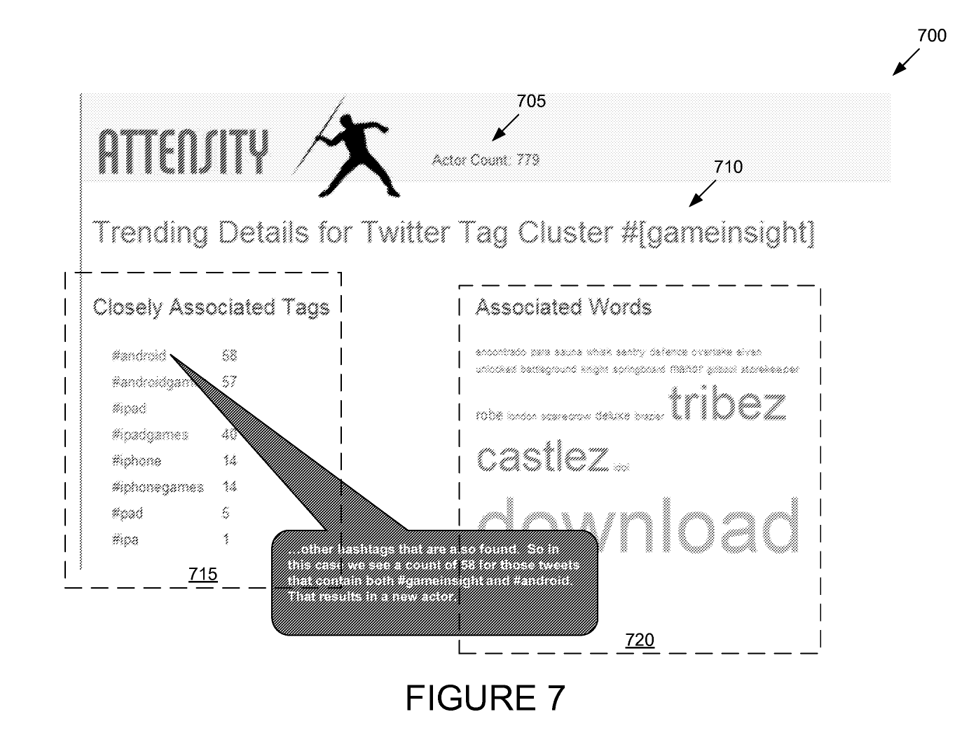

FIG. 7 depicts an example report 700 showing analysis of a particular hashtag from a public data source 105, according to some embodiments. The report 700 may be displayed when a user selects a hashtag of interest, “#gameinsight,” shown in the trending hashtag panel 610 in FIG. 6. The report 700 may have been generated by the report generation engine 280, shown in FIG. 2.

The report 700 includes an actor count 705, a title bar 710, a closely associated hashtags panel 715, and an associated words panel 720. The actor count 705 may display the number of executing actors that are associated with the hashtag of interest. The title bar 710 may provide a title for the report 700.

The closely associated hashtags panel 715 may display other hashtags that are commonly associated with the hashtag of interest. In this example, commonly associated hashtags include the hashtags “#android,” “#androidgames,” “#ipad,” “#ipadgames,” “#iphone,” “#iphonegames,” “#pad,” and ““#ipa.” Filter actors 215 created for the hashtag of interest may cause the creation of other actors (e.g., other filter actors, correlation actors, complex event actors, etc.) that parse content items having the hashtag of interest for the presence of other hashtags. The other actors may also count the occurrence of the other hashtags. The closely associated hashtags panel 715 may display the other hashtags and the number of times these other hashtags appear in content items having the hashtags of interest.

The associated words panel 720 may display words associated with the hashtag of interest. In this example, a variety of words are shown as associated with the hashtag of interest. Filter actors 215 created for the hashtag of interest may create deep review actors 235 that perform deep review processing of content items associated with the hashtag of interest. The associated words panel 720 may display the results of deep review processing of these content items.

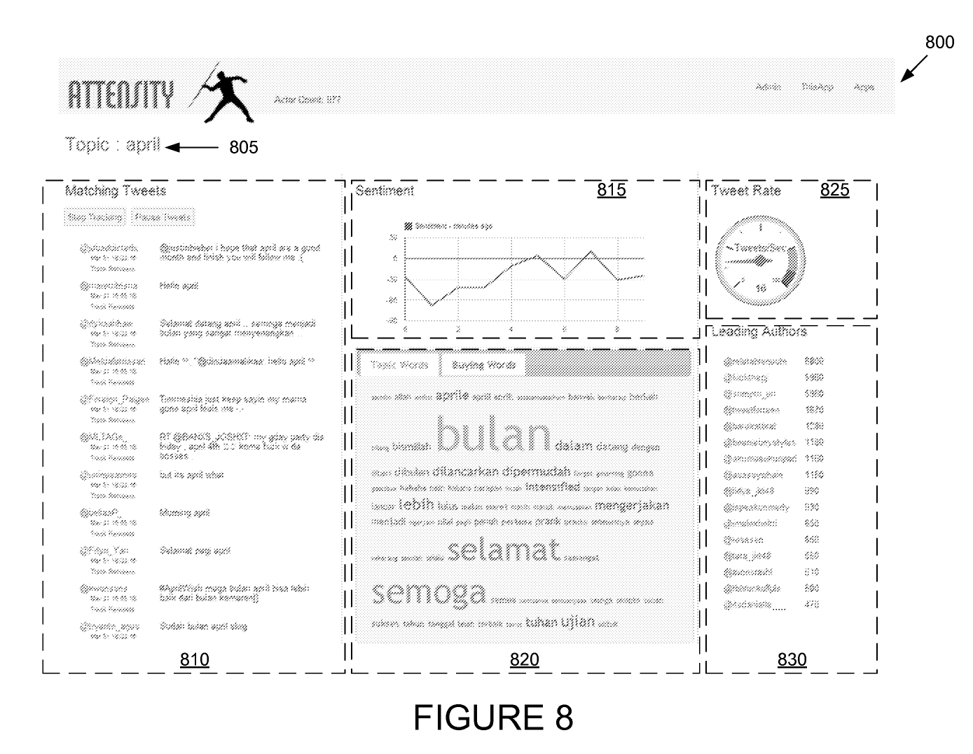

FIG. 8 depicts an example report 800 showing analysis of a particular topic of interest, according to some embodiments. The report 800 may be displayed when a user enters the topic of interest into the topic tracking engine 645 shown in FIG. 6. The report 800 may have been generated by the report generation engine 280, shown in FIG. 2.

The report 800 includes a title bar 805, a matching content item panel 810, a sentiment panel 815, a deep review panel 820, a posting rate panel 825, and a leading author list panel 830. The title bar 805 displays a title for the report 800. The matching content item panel 810 displays a list of content items that are associated with the topic of interest. The list of content items may include those content items that satisfy filter criteria related to the topic of interest. For example, the list of content items may satisfy filter criteria used by filter actors to identify content items containing the word “april.”

The sentiment panel 815 may display sentiment related to content items that are associated with the topic of interest. The sentiment panel 815 may display at least a portion of how deep review actors 235 have processed the content items satisfying the filter criteria at a given time. The deep review panel 820 may display other information from deep review processing of the content items that satisfy the filter criteria for the topic of interest. For example, the deep review panel 820 may display topic words, buying words, or other types of words found in the content items satisfying the filter criteria for the topic of interest.

The posting rate panel 825 may display the number of content items about the topic of interest over a period of time. In the example of FIG. 8, the posting rate panel 825 shows the number of content items posted per second about the topic “april” in the weblogging source 105(a). In various embodiments, the posting rate may be based on results from filter actors. The leading author list panel 830 may display information about authors who are posting content items related to the topic of interest. In the illustrated example, the leading author list panel 830 shows the leading authors who are posting about the topic of interest. In some embodiments, the authors in the leading author list panel 830 may be based on results from filter actors 215.

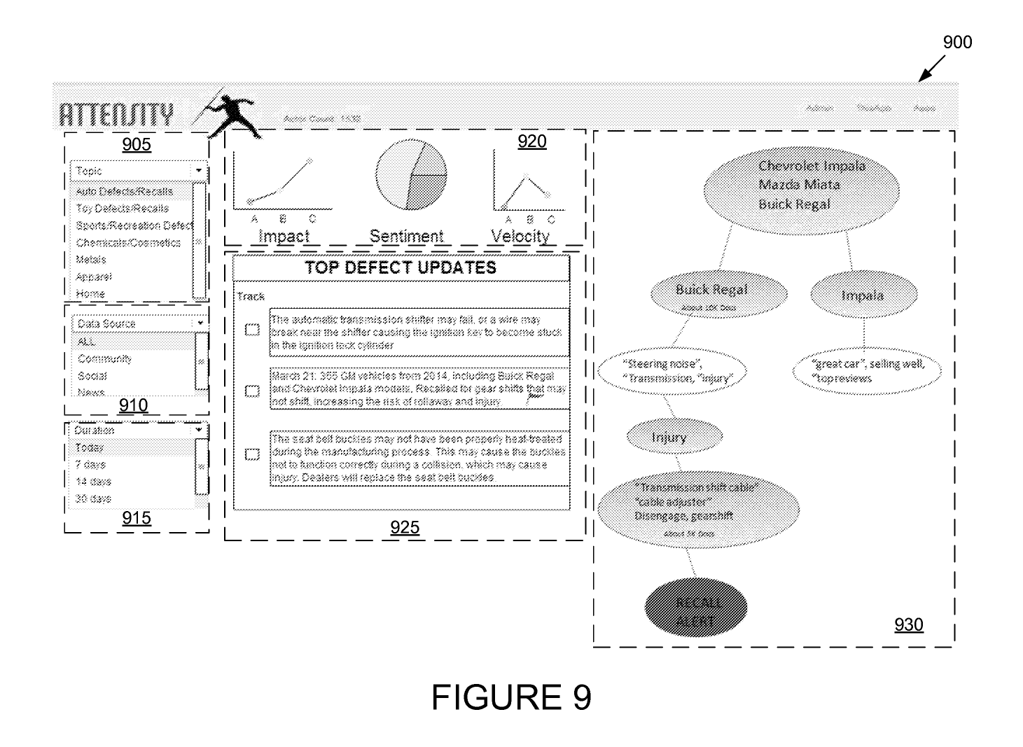

FIG. 9 depicts an example report 900 showing patterns associated with content items related to one or more topics of interest, according to some embodiments. The report 900 may have been generated by the report generation engine 280, shown in FIG. 2. The report 900 includes a pattern selection panel 905, a data source selection panel 910, a duration panel 915, a deep review results panel 920, a particular pattern tracking panel 925, and a pattern mapping panel 930.

The pattern selection panel 905 may allow a user to select a specific pattern to track. In some embodiments, the pattern selection panel 905 may include a drop-down menu that lists potential patterns that may be present in content items in the public data sources 105 and/or the private data sources 140. The pattern selection panel 905 shown in FIG. 9 lists the following potential patterns that may be present in content items: “Auto Defects/Recalls,” “Toy Defects/Recalls,” “Sports/Recreation Defects,” “Chemicals/Cosmetics,” “Metals,” “Apparel,” and “Home.” Each of these potential patterns may comprise the results of analysis of content items in public data sources 105 and/or the private data sources 140, shown in FIG. 1. In the example of FIG. 9, the topic “Auto Defects/Recalls” has been selected for the report 900.

The data source selection panel 910 allows the user to select one or more data sources for the report 900. The data source selection panel 910 may include a drop-down menu that lists potential data sources. For instance, the following data sources may be listed, “ALL,” “Community,” “Social,” News,” etc. In some embodiments one or more of the data sources listed in the data source selection panel 910 may correspond to one or more of the public data sources 105 and the private data sources 140, shown in FIG. 1. In this example, all data sources have been selected for the report.

The duration panel 915 may provide a box that allows a user to specify a time frame for the report 900. In some embodiments, the duration panel 915 may include a drop-down menu that lists potential time frames. For example, the duration panel 915 may include the following durations: the same day as the selection (labeled “today”), seven days before the selection, fourteen days, thirty days, etc. In this example, the same day as the selection has been chosen for the report 900.

The deep review results panel 920 may display types of deep review processing of content items forming the basis of the report 900. The deep review results panel 920 may display semantic elements such as impact, sentiment, and velocity related to the topics of interest. The particular pattern tracking panel 925 may allow the user to track one or more particular patterns for the report 900. In this example, the list of particular patterns may be related to the pattern selected by the pattern selection panel 905, namely “Auto Defect/Recalls.” The list of particular patterns may provide top patterns related to “Auto Defects/Recalls.” For instance, the list of particular patterns may provide patterns associated with failure of various automobile components, information about particular automobile models that have been recalled, and particular manufacturing defects (e.g., defects associated with seatbelt manufacturing processes).

The pattern mapping panel 930 may map patterns in the report 900. The pattern mapping panel 930 may show several models of automobiles (e.g., “Chevrolet Impala,” “Mazda Miata,” and Buick Regal”) for which automobile defect or recall information is being sought. The pattern mapping panel 930 may show that there are postings providing automobile defect or recall information related to the models “Buick Regal” and “Chevrolet Impala.” The pattern mapping panel 930 may further identify the words “Steering noise,” “Transmission,” and “Injury” to be frequently associated with the model Buick Regal, and identify the words “great car,” “selling well,” and “top reviews” to be frequently associated with the model Chevrolet Impala. As the word “Injury,” used in relation to the Buick Regal, may correlate with automobile defect or recall content items, the word “Injury” may be identified for deep review processing. Further processing of the word “Injury” may reveal postings with the language, “Transmission shift cable,” “cable adjuster,” “Disengage,” and “gearshift.” Processing of this language may result in a recommendation to provide a recall.

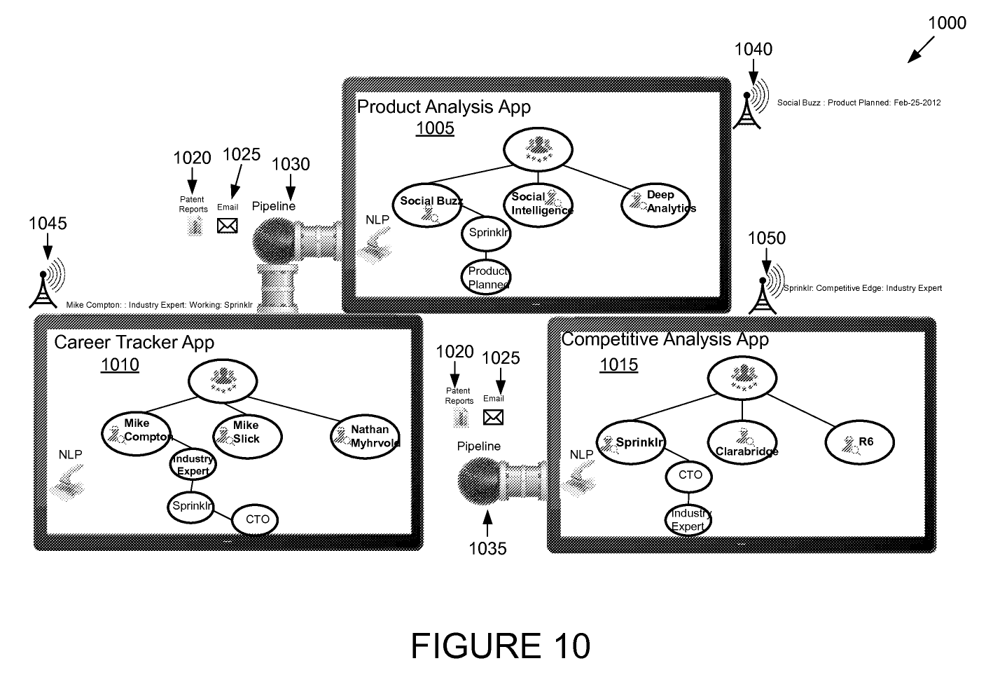

FIG. 10 is block diagram depicting a network 1000 of three applications that predict different patterns related to an event posted in patent reports and emails, according to some embodiments. The network 1000 includes a first subnet 1005 of a product analysis application, a second subnet 1010 of a career tracking application, and a third subnet 1015 of a competitive analysis application. The network 1000 further includes a first data source 1020 comprising a source of patent reports, and a second data source 1025 comprising a source of emails. The network 1000 includes a first information pipeline 1030 and a second information pipeline 1035. The network 1000 further includes a product analysis prediction 1040, a career tracking prediction 1045, and a competitive analysis prediction 1050.

The product analysis application may provide predictions about products that are being developed. The career tracking application may provide predictions about career changes of specific individuals. The competitive analysis application may provide predictions about market positions of a company. The predictions by the product analysis application, the career tracking application, and the competitive analysis application may be based on information from the first data source 1020 and the second data source 1025. Further, the first information pipeline 1030 may provide information from the first data source 1020 and the second data source 1025 to the product analysis application and to the career tracking application. The first information pipeline 1030 may also allow data to be transferred between the product analysis application and the career tracking application. The second information pipeline 1035 may provide information from the first data source 1020 and the second data source 1025 to the competitive analysis application.

The product analysis prediction 1040 may include a prediction of a product that is likely to be planned for launch. The product analysis prediction 1040 may be provided by the product analysis application. The career tracking prediction 1045 may include a prediction of a career change of a particular individual. The career tracking prediction 1045 may be provided by the career tracking application. The competitive analysis prediction 1050 may include a prediction of a change in competitive position of a specific business. The product analysis prediction 1040, the career tracking prediction 1045, and the competitive analysis prediction 1050 may be based on analysis of information in the first data source 1020 and the second data source 1025. Each of the product analysis prediction 1040, the career tracking prediction 1045, and the competitive analysis prediction 1050 may provide different predictions based on the common set of patent reports and emails that form the basis of the first data source 1020 and the second data source 1025.

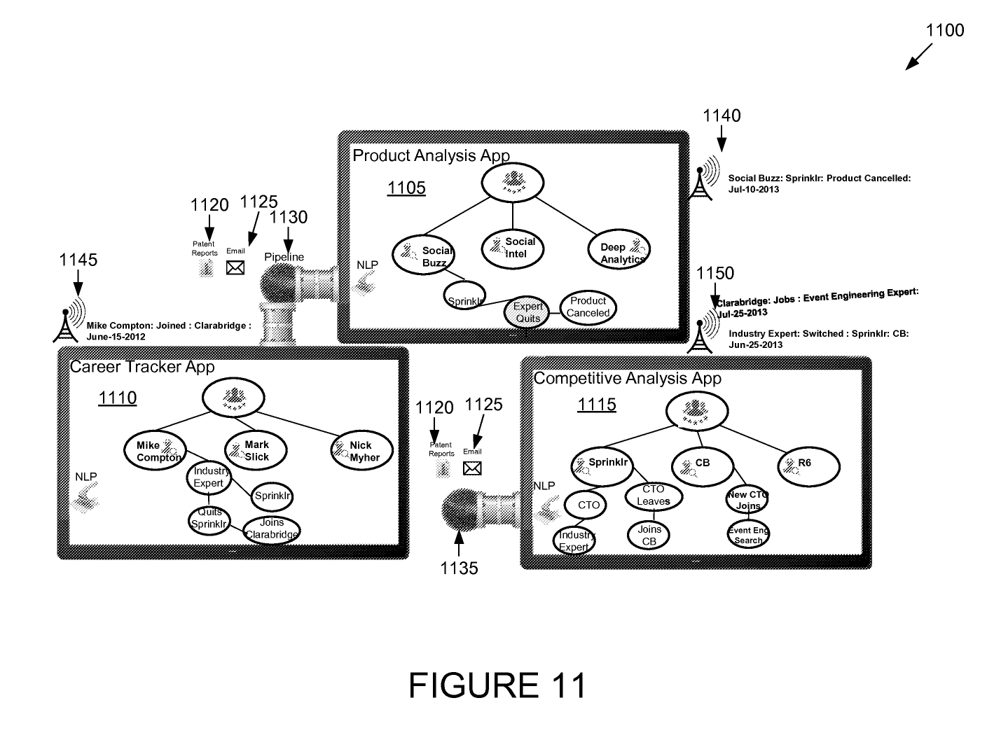

FIG. 11 is a block diagram that depicts a network 1100 of three applications that predict different patterns related to an event posted in patent reports and emails, according to some embodiments. The network 1100 includes a first subnet 1105 of a product analysis application, a second subnet 1110 of a career tracking application, and a third subnet 1115 of a competitive analysis application. The network 1100 further includes a first data source 1120 comprising a source of patent reports, and a second data source 1125 comprising a source of emails. In the example of FIG. 11, the network 1100 includes a first information pipeline 1130 and a second information pipeline 1135. The network 1100 further includes a product analysis prediction 1140, a career tracking prediction 1145, and a competitive analysis prediction 1150. The elements of the network 1100 may operate similarly to corresponding elements shown in the network 1000 of FIG. 10.

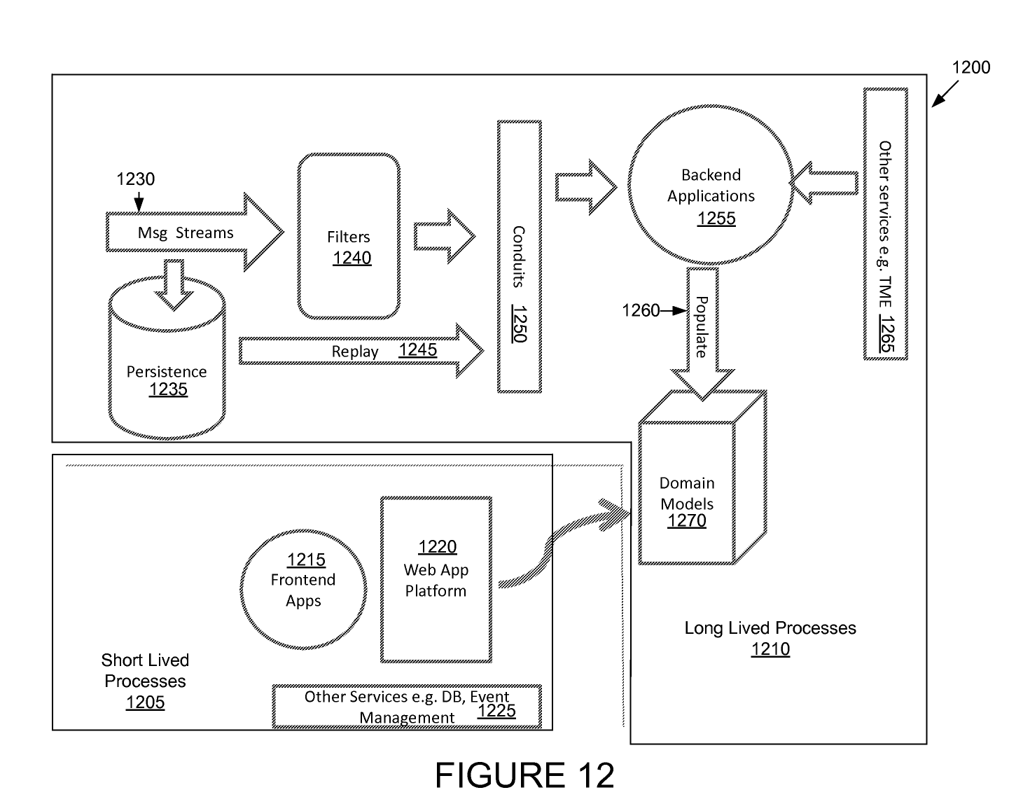

FIG. 12 is a block diagram illustrating a system architecture 1200 for analyzing data using actors, according to some embodiments. The system architecture 1200 may include short lived processes 1205 and long lived processes 1210. The short lived processes 1205 may include frontend applications 1215, a web application platform 1220, and other services 1225. Examples of other services 1225 include databases and event management services. In various embodiments, the short lived processes 1205 provide data as the data is needed for various use cases. The long lived processes 1210 include message streams 1230, persistence 1235, filters 1240, replay streams 1245, conduits 1250, backend applications 1255, populate streams 1260, other services 1265, and domain models 1270. In some embodiments, the long lived processes 1310 are instantiated and run continuously for an extended duration of time, e.g., weeks or months.

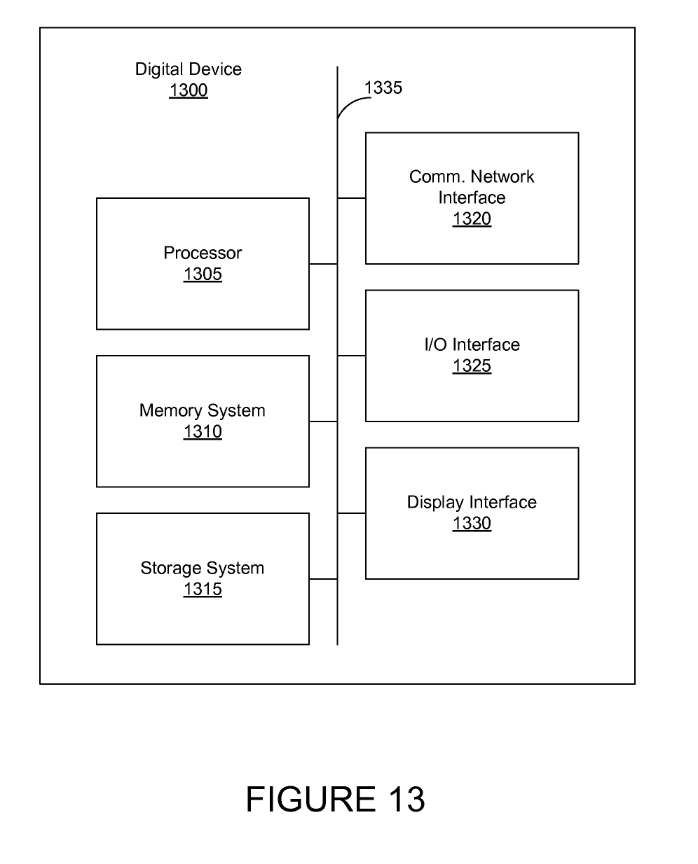

FIG. 13 depicts an example of a digital device 1300, according to some embodiments. The digital device 1300 comprises a processor 1305, a memory system 1310, a storage system 1315, a communication network interface 1320, an Input/output (I/O) interface 1325, a display interface 1330, and a bus 1335. The bus 1335 may be communicatively coupled to the processor 1305, the memory system 1310, the storage system 1315, the communication network interface 1320, the I/O interface 1325, and the display interface 1330.

In some embodiments, the processor 1305 comprises circuitry or any processor capable of processing the executable instructions. The memory system 1310 comprises any memory configured to store data. Some examples of the memory system 1310 are storage devices, such as RAM or ROM. The memory system 1310 may comprise the RAM cache. In various embodiments, data is stored within the memory system 1310. The data within the memory system 1310 may be cleared or ultimately transferred to the storage system 1315.

The storage system 1315 comprises any storage configured to retrieve and store data. Some examples of the storage system 1315 are flash drives, hard drives, optical drives, and/or magnetic tape. In some embodiments, the digital device 1300 includes a memory system 1310 in the form of RAM and a storage system 1315 in the form of flash data. Both the memory system 1310 and the storage system 1315 comprise computer readable media which may store instructions or programs that are executable by a computer processor including the processor 1305.

The communication network interface (com. network interface) 1320 may be coupled to a data network. The communication network interface 1320 may support communication over an Ethernet connection, a serial connection, a parallel connection, or an ATA connection, for example. The communication network interface 1320 may also support wireless communication (e.g., 802.11 a/b/g/n, WiMAX, LTE, 3G, 2G). It will be apparent to those skilled in the art that the communication network interface 1320 may support many wired and wireless standards.

The optional input/output (I/O) interface 1325 is any device that receives input from the user and output data. The display interface 1330 is any device that may be configured to output graphics and data to a display. In one example, the display interface 1330 is a graphics adapter.

It will be appreciated by those skilled in the art that the hardware elements of the digital device 1300 are not limited to those depicted in FIG. 13. A digital device 1300 may comprise more or less hardware elements than those depicted. Further, hardware elements may share functionality and still be within various embodiments described herein. In one example, encoding and/or decoding may be performed by the processor 1305 and/or a co-processor located on a GPU.

The above-described functions and components may be comprised of instructions that are stored on a storage medium such as a computer readable medium. The instructions may be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with some embodiments. Those skilled in the art are familiar with instructions, processor(s), and storage medium.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment,” “an embodiment,” “some embodiments,” “various embodiments,” “certain embodiments,” “other embodiments,” “one series of embodiments,” or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope be limited not by this detailed description, but rather by any claims that issue on an application based hereon. Accordingly, the disclosure of the embodiments is intended to be illustrative, but not limiting, of the scope, which is set forth in the following claims.

What is claimed is:

1. A system comprising:
a filter actor execution system configured to execute one or more filter actors to identify content items relevant to a topic of interest, each filter actor configured to examine the content items for satisfaction of filter criteria and to identify a subset of content items that satisfy the filter criteria;
a deep review actor execution system configured to execute one or more deep review actors to conduct deep review processing of the subset of content items, each deep review actor configured to perform semantic analysis on the subset of content items to generate deep review actor data;
a correlation actor execution system configured to execute one or more correlation actors to identify one or more links within the subset of content items;
a complex event actor execution system configured to execute one or more complex event actors to identify one or more patterns within the subset of content items; and
an actor management system configured to instantiate the one or more filter actors, the one or more deep review actors, the one or more correlation actors, and the one or more complex event actors.

2. The system of claim 1, wherein the actor management system includes at least one of a filter actor template, a deep review actor template, a correlation actor template and a complex event actor template.

3. The system of claim 1, wherein at least one filter actor, deep review actor, correlation actor or complex event actor has a finite lifespan.

4. The system of claim 3, wherein the at least one filter actor, deep review actor, correlation actor or complex event actor terminates after a predetermined time, after an occurrence of a predetermined event, or after a manual instruction.

5. The system of claim 1, wherein at least one of the one or more filter actors, deep review actors, correlation actors or complex event actors is a parent actor, and the parent actor assists in generating a child filter actor, a child deep review actor, a child correlation actor or a child complex event actor.

6. The system of claim 5, wherein the child filter actor, the child deep review actor, the child correlation actor or the child complex event actor terminates in response to termination of the parent actor.

7. The system of claim 1, wherein the complex event actor execution system is further configured to execute the one or more complex event actors to make a prediction, recommendation or decision based on the one or more identified patterns.

8. The system of claim 1, wherein the one or more filter actors include at least one private filter actor.

9. The system of claim 1, wherein the one or more filter actors include at least one public filter actor.

10. A method comprising:
instantiating one or more filter actors, one or more deep review actors, one or more correlation actors, and one or more complex event actors;
executing the one or more filter actors to identify content items relevant to a topic of interest, each filter actor configured to examine the content items for satisfaction of filter criteria and to identify a subset of content items that satisfy the filter criteria;
executing the one or more deep review actors to conduct deep review processing of the subset of content items, each deep review actor configured to perform semantic analysis on the subset of content items to generate deep review actor data;
executing the one or more correlation actors to identify one or more links within the subset of content items; and
executing the one or more complex event actors to identify one or more patterns within the subset of content items.

11. The method of claim 10, wherein the instantiating includes using at least one of a filter actor template, a deep review actor template, a correlation actor template and a complex event actor template.

12. The method of claim 10, further comprising automatically terminating at least one filter actor, deep review actor, correlation actor or complex event actor.

13. The method of claim 12, wherein the automatically terminating the at least one filter actor, deep review actor, correlation actor or complex event actor occurs after a predetermined time, after an occurrence of a predetermined event, or after a manual instruction.

14. The method of claim 10, wherein at least one of the one or more filter actors, deep review actors, correlation actors or complex event actors is a parent actor, and further comprising receiving information from the parent actor to assist in generating a child filter actor, a child deep review actor, a child correlation actor or a child complex event actor.

15. The method of claim 14, further comprising automatically terminating the child filter actor, the child deep review actor, the child correlation actor or the child complex event actor in response to termination of the parent actor.

16. The method of claim 10, further comprising executing the one or more complex event actors to make a prediction, recommendation or decision based on the one or more identified patterns.

17. The method of claim 10, wherein the one or more filter actors include at least one private filter actor.

18. The method of claim 10, wherein the one or more filter actors include at least one public filter actor.
